(19) United States
(12) Patent Application Publication
(10) Pub. No.: US 2026/0321126 A1
(43) Pub. Date: Oct. 15, 2026

(54) APPARATUS, SYSTEM AND METHODS FOR COMMERCIAL FIRE PROGRAMMABLE COMMUNICATOR MODEM AND/OR SWITCH

(71) Applicants: BRIAN KOWALKOWSKI, DES PLAINES, IL (US); KENNETH SCOTT VOLKENING, CHICAGO, IL (US); KEN R. VOLKENING, HAMPSHIRE, IL (US)

(72) Inventors: BRIAN KOWALKOWSKI, DES PLAINES, IL (US); KENNETH SCOTT VOLKENING, CHICAGO, IL (US); KEN R. VOLKENING, HAMPSHIRE, IL (US)

(21) Appl. No.: 19/645,916

(22) Filed: Apr. 13, 2026

Related U.S. Application Data
(60) Provisional application No. 63/787,133, filed on Apr. 11, 2025.

(51) Int. Cl. G08B 29/12; G08B 17/00

(52) U.S. Cl. CPC G08B 29/12; G08B 17/00

(57) ABSTRACT

The present disclosure is directed to a system and methods for incorporating an improved modem in connection with or integrated with a commercial fire programmable communicator, and in particular, the present disclosure relates to a system and methods for a novel modem design, as well as related field application needs, that enhance performance, scalability and security for a wide range of communication applications, specifically for the purpose of the fire alarm industry, which further incorporates key features and components within National Fire Alarm and Signaling Code (NFPA 72) put out by the National Fire Protection Association.

### PRIORITY STATEMENT

This application claims benefit to U.S. provisional patent application Ser. No. 63/787,133, entitled SYSTEM AND METHODS FOR COMMERCIAL FIRE PROGRAMMABLE COMMUNICATOR MODEM, filed Apr. 11, 2025, the disclosure of which is herein incorporated by reference in its entirety.

### FIELD OF THE DISCLOSURE

The present disclosure relates to an apparatus, system and methods for incorporating an improved modem and/or switch in connection with or integrated with a commercial fire programmable communicator, and in particular, the present disclosure relates to an apparatus, system and methods for a novel modem and/or switch design, as well as related field application needs, that enhance performance, scalability and security for a wide range of communication applications, specifically for the purpose of the fire alarm industry, which further incorporates key features and components within National Fire Alarm and Signaling Code (NFPA 72) put out by the National Fire Protection Association.

### BACKGROUND OF THE DISCLOSURE

Modems, or modulator-demodulators, are devices used in telecommunications, allowing digital data to be transmitted over analog communication channels, such as telephone lines, coaxial cables, or radio frequencies. The role of a modem is to convert digital signals generated by computers or other digital devices into analog signals suitable for transmission, and conversely, to convert incoming analog signals back into digital signals that the receiving device can process. This technology has been instrumental in enabling internet access, remote communication, and data transfer for decades. A switch is a device for making or breaking a connection in an electric circuit. The apparatus disclosed herein uses the term modem in certain instances to incorporate a switch that makes or breaks an electrical connection.

Traditional modems typically operate at various transmission speeds, with performance being influenced by factors such as line quality, distance from the transmission source, and the type of modulation technique used. Over the years, advances in communication protocols, signal processing algorithms, and modulation techniques have led to the development of high-speed modems capable of handling increased data rates, providing faster internet and communication services to end-users.

Further, existing modem solutions may not fully address the increasing security and safety concerns in modern communication systems. As the demand for secure, reliable data transmission grows, so does the need for modems with enhanced features, encryption, authentication, and data integrity mechanisms to protect sensitive safety communications.

In particular, fire alarm systems are crucial for ensuring safety in residential, commercial, and industrial environments by detecting fires and alerting occupants and emergency personnel. Traditional fire alarm systems are often equipped with various detection devices such as smoke detectors, heat detectors, and carbon monoxide sensors. These systems rely on wired or wireless communication technologies to transmit signals between different components, such as sensors, control panels, and remote notification devices.

A critical aspect of modern fire alarm systems is the communication infrastructure that enables the rapid and reliable transmission of alarm signals and status updates. In many instances, this communication is facilitated through various wired or wireless communication methods, including RF (radio frequency) signals, Wi-Fi, and cellular networks.

However, existing communication methods in fire alarm systems face several challenges, including limited range, interference, and security vulnerabilities. Additionally, many fire alarm systems are designed with fixed or limited communication protocols, which may not be adaptable to new technologies or emerging communication standards.

The need for more reliable, secure, and adaptable communication solutions for fire alarm systems has become apparent. Particularly, modems designed to interface with these systems are critical for enabling more flexible and robust communication. A modem that provides an improved interface between fire alarm system equipment and remote monitoring stations, emergency personnel, and other external systems can address many of the shortcomings of current technologies. The modem needs to offer enhanced data transmission reliability, reduced susceptibility to interference, and secure communication that can withstand external threats, ensuring the integrity and effectiveness of the fire alarm system.

There have been many recent changes in the fire alarm industry. NFPA 72, known as the National Fire Alarm and Signaling Code put out by the National Fire Protection Association, historically did not permit the use of cloud-based or Internet-based products. However, in recent years there has been a reduction of copper Plain Old Telephone Service (POTS) lines. The Federal Communications Commission (FCC) issued an order (Order 19-72A1), which officially granted telecommunications carriers permission to stop maintaining the copper POTS grid.

Instead, NFPA 72 has permitted fire alarm system equipment manufacturers to utilize cloud-based Internet of Things (IOT) devices on commercial fire alarm systems. NFPA 72 maintains a strict standard that every device on a fire alarm system needs to be Underwriters Laboratories (UL) listed and have a UL Commercial Fire Listing. As it turns out, the only device exception to being UL listed allowed by NFPA 72 is a modem.

Along those lines, there exists a need for an improved modem that can enhance communication between fire alarm system equipment, enabling better performance, adaptability, safety, and security. The present invention seeks to address these needs by providing a novel modem that offers specific, efficient, and reliable communication for fire alarm system applications.

Various patents and patent applications have attempted to address the disadvantages of the existing modem devices, systems and methods described herein. One example that pertains to a smart fire management system, is South Korea Patent No. 101697935, titled System for Controlling Smart Fire, disclosing a smart fire management system which not only enables a user to easily verify a position or to easily suppress a fire in an early stage when a fire occurs by installing an adaptor including a wire/wireless communication function in a fire detector, and realizing a network-based fire receiver, but also verifies a cause of the fire by continuously monitoring and controlling firefighting facilities, and also enables a user to easily perform maintenance of a history management of various devices, an automatic checkup, a malfunction, a replacement period, and so on.

Another patent that pertains to an apparatus and method for control such as in a building or in a vehicle using a server implementing gateway or control functionalities, is U.S. Pat. No. 11,824,933, titled System and method for server based control, which discloses a system and method in a building or vehicle for an actuator operation in response to a sensor according to a control logic, the system comprising a router or a gateway communicating with a device associated with the sensor and a device associated with the actuator over in-building or in-vehicle networks, and an external Internet-connected control server associated with the control logic implementing a PID closed linear control loop and communicating with the router over external network for controlling the in-building or in-vehicle phenomenon. The sensor may be a microphone or a camera, and the system may include voice or image processing as part of the control logic. A redundancy is used by using multiple sensors or actuators, or by using multiple data paths over the building or vehicle internal or external communication. The networks may be wired or wireless, and may be BAN, PAN, LAN, WAN, or home networks.

Another patent that pertains to improvements in science and technology applied against ravaging and destructive forces of wildfires, U.S. patent application Ser. No. 18/492,649, titled Neighborhood of homes provided with a system installed for proactively forming and maintaining environmentally-clean chemical fire protection zones over the property and ground surfaces of the neighborhood. The application discloses a neighborhood of buildings or homes, provided with a system for forming and maintaining GPS tracked and mapped environmentally-clean chemical-based fire protection zones formed over property and ground surfaces in and about the neighborhood of homes, that proactively inhibit fire ignition and flame spread when exposed to wild fire. The system includes a GPS-tracking anti-fire (AF) liquid spraying system wirelessly connected to a wireless communication network supporting a network database. The GPS-tracked anti-fire liquid spraying system is used to spray particular GPS-specified ground surfaces in and about the buildings and neighborhood, with an environmentally-clean anti-fire chemical liquid so to form environmentally-clean chemical fire protection zones over the GPS-specified property surfaces, while generating GPS-coordinate and time/date stamped data records pertaining to the application of the environmentally-clean anti-fire chemical liquid spray during the formation of the environmentally-clean chemical fire protection zones. The GPS-coordinate and time/date stamped data records are transmitted over the wireless communication network for storage in the network database. A mobile computing system is used to access the GPS-coordinate and time/date stamped data records from the network database, relating to the formation of the GPS-specified environmentally-clean chemical fire protection zones, so as to verify that the GPS-specified environmentally-clean chemical fire protection zones were formed at the GPS-specified property surfaces on the particular date, to proactively inhibit fire ignition and flame spread when exposed to wild fire.

However, none of these references successfully address the disadvantages and limitations of the current modem design to enhance performance, scalability, and security, specifically for the purpose of the fire alarm industry. At a minimum, none of the references disclose an apparatus, system or methods that provide a novel modem that offers specific, efficient, and reliable communication for fire alarm system applications.

Further, none of these references disclose, suggest, or teach a novel modem design that enhances performance, scalability, and security for a wide range of communication applications, specifically for the purpose of the fire alarm industry and key features and components within NFPA 72 as well as field application needs. The present disclosure satisfies these needs.

### SUMMARY OF THE DISCLOSURE

In the current version of NFPA code and the upcoming 2025 NFPA code, modems are the only devices or products that can be utilized on a commercial fire alarm system without having a UL Commercial Fire Listing. It is also believed that the fire protection industry is not only moving into the cloud-based industry but has already been involved with cloud based IOT Products in recent years. While the development of higher end modems for the purpose of industrial and commercial applications has been developed, a substantial unfilled need still exists in not specifically having a UL Commercial Fire Modem. In one embodiment, this modem shall be manufactured and listed for the sole purpose of the fire alarm industry and some specific key features and components for some specific reasons within NFPA 72, as well as field application needs.

Some of the relevant NFPA 72 code includes the following provisions:
NFPA 72: 26.6.3.13.1 Premises Equipment. The secondary power capacity for all transmitters and shared equipment necessary for the transmission of alarm, supervisory, trouble, and other signals located at the protected premises shall be a minimum of 24 hours or as permitted by 10.6.7.3.1(2), 26.6.3.13.1.1, or 26.6.3.13.1.2.
NFPA 72: 26.6.3.2 Communications Integrity. Provisions shall be made to monitor the integrity of the transmission technology and its communications path.
NFPA 72: 26.6.3.3 Single Communications Path. Unless prohibited by the enforcing authority, governing laws, codes, or standards, where single communications path is used, the following requirements shall be met: (1) the path shall be supervised at an interval of not more than 60 minutes; (2) a failure of the path shall be annunciated at the supervising station within not more than 60 minutes; (3) The failure to complete a signal transmission shall be annunciated at the protected premises in accordance with Section 10.15.
NFPA 72: 26.6.3.4 Multiple Communication Paths. If multiple transmission paths are used, the following requirements shall be met: (1) each path shall be supervised within not more than 6 hours; (2) the failure of any path of a multipath system shall be annunciated at the supervising station within not more than 6 hours; (3) multiple communications paths shall be arranged so that a single point of failure shall not cause more than a single path to fail; (4) the failure to complete a signal transmission shall be annunciated at the protected premises in accordance with Section 10.5.
NFPA 72: 10: Equipment: Equipment constructed and installed in conformity with this Code shall be listed for the purpose for which it is used.

While higher end modems for the purpose of industrial and commercial applications have been developed, it is also necessary for the fire protection industry to move into the cloud-based industry, and it has already incorporated cloud-based Internet Of Things (IOT) products. However, a substantial unfilled need still exists in not specifically having a UL commercial fire modem. The present invention seeks to address these needs by providing a novel modem design that enhances performance, scalability, and security for a wide range of communication applications, specifically for the purpose of the fire alarm industry and key features and components within NFPA 72 as well as field application needs.

In general, and in order to solve the above-mentioned shortcomings in current modem design to enhance performance, scalability, and security, specifically for the purpose of the fire alarm industry, Applicants have created a standalone and/or combination novel modem model that is put through UL for a UL Listed Commercial Fire Programmable Communicator featuring all the following features that would all be capable of reporting to a central station as a standalone modem or a combination Modem & Fire Panel IP Communicator. This would be the first model to encompass all the features and abilities that the current generation of modems and IP Communicators do not achieve, including, but not limited to:
Universal Form C Relay #1 output connected to a fire alarm system for loss of AC or DC Power.
Universal Form C Relay #2 output connected to a fire alarm system for following: Low Backup Battery
Universal Form C Relay #3 output connected to a fire alarm system for following: Loss of IP “Internet Protocol”

Internal backup battery with an additional pair of wires to connect externally to any 12 Volt Battery to reach a 24-hour minimum.

Optional Backup Cellular Antennas, which can be used when the primary ISP or backup SIM card is being utilized for communication functionality.

Programmable USB Port, which provides highly reliable USB communications in industrial environments, can be used for hardware-in-the-loop testing and system development.

Remote management Network Cable (CAT5/CAT6 Port), which may include an RJ45 port, which is used for remotely accessing, configuring, or controlling various devices (including the fire alarm modem described herein), often bypassing the main operating system of a server or networking equipment.

Unit and accessories will all be housed in metal (red) locked enclosure.

Universal non-proprietary programming aimed for partnerships with any Fire Alarm Equipment Manufacturer for use in combination with their current UL Fire Communicator.

As such, it is an object of the present disclosure to provide a standalone novel modem that is put through UL for a UL Listed Commercial Fire Programmable Communicator featuring all the features described herein and that would be capable of reporting to a central station as a standalone Modem & Fire Panel IP Communicator.

It is also an object of the present disclosure to provide a combination novel modem that is put through UL for a UL Listed Commercial Fire Programmable Communicator featuring all the features described herein and that would be capable of reporting to a central station as a combination Modem & Fire Panel IP Communicator.

These and other aspects, features, and advantages of the present disclosure will become more readily apparent from the attached drawings and the detailed description of the preferred embodiments, which follow.

### DRAWINGS

The preferred embodiments of the disclosure will be described in conjunction with the appended drawings provided to illustrate and not to the limit the disclosure, where like designations denote like elements, and in which:

FIG. 1 illustrates a functional block diagram for an improved fire alarm system in accordance with one embodiment of the present disclosure;

FIG. 2 illustrates an improved fire alarm system modem in accordance with one embodiment of the present disclosure;

FIG. 3 illustrates a functional block diagram for an improved fire alarm system in accordance with one embodiment of the present disclosure;

FIG. 4 illustrates an improved integrated fire alarm system modem in accordance with one embodiment of the present disclosure;

FIG. 5 illustrates an enclosure for the integrated fire alarm system modem in accordance with one embodiment of the present disclosure.

### DETAILED DESCRIPTION

Referring to the drawings, wherein like reference numerals refer to the same or similar features in the various views, the present disclosure pertains to an improved fire alarm system and methods for improving fire alarm systems to solve the well-known shortcomings in the fire alarm system industry, including improvements to the fire alarm system modem incorporated into the fire alarm system.

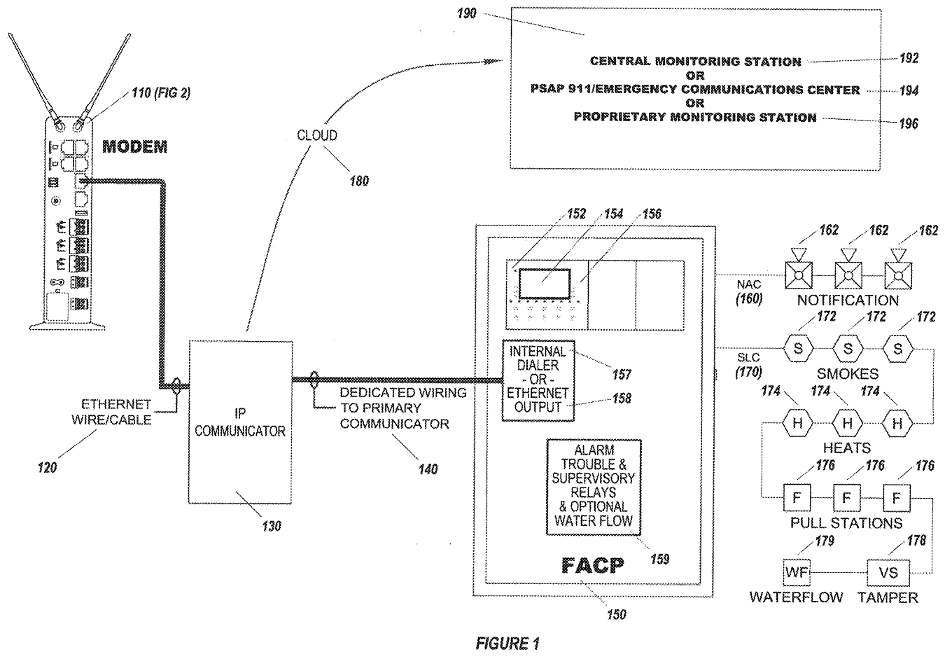

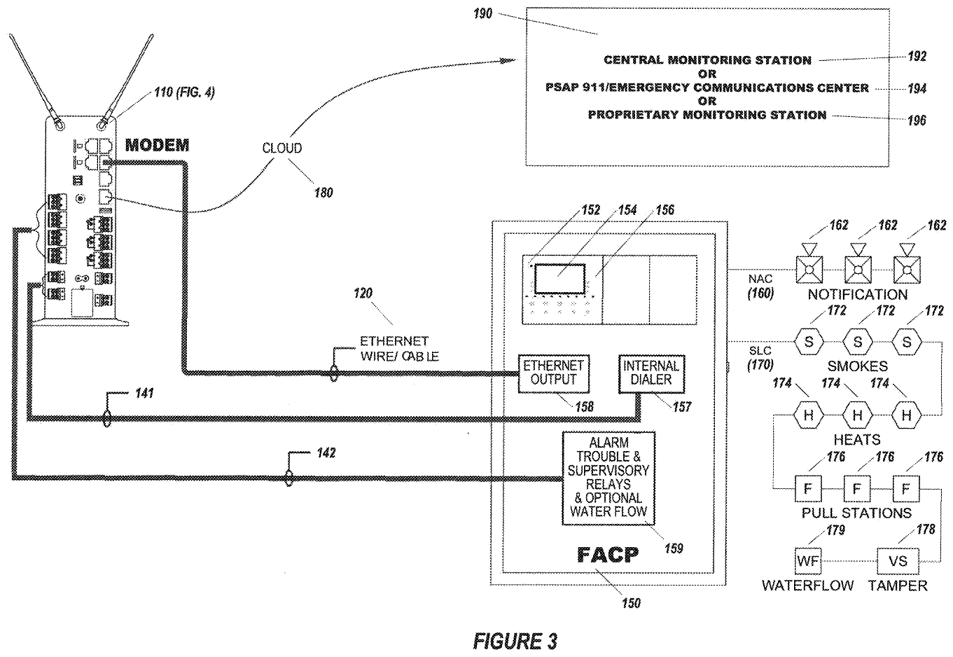

FIGS. 1 and 3 show exemplary functional block diagrams for the improved fire alarm system 100 in accordance with one embodiment of the present disclosure. The modem 100 can be fully supervised with or without a built-in communicator for control, remote or proprietary station monitoring. The fire alarm system 100 is made up of multiple components that may be separate components or may be combined into one or more integrated assemblies, depending on the physical location of the components in relation to the other components, cost efficiencies, functionality of the components in relation to the other components, and other factors.

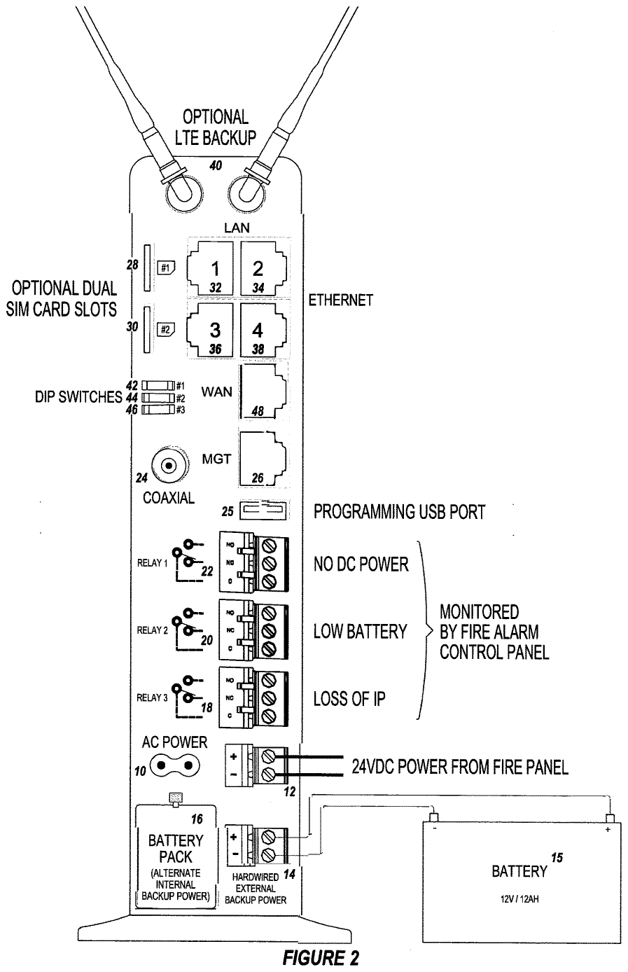

An exemplary fire alarm system 100 shown in FIG. 1 is made up of the improved modem 110 (detailed below and in FIG. 2), connected using an ethernet wire or cable 120 to an IP communicator 130, which is connected using dedicated wiring 140 between the IP communicator 130 and a Fire Alarm Control Panel (FACP) 150. The FACP 150 is generally a central unit that monitors and controls the fire alarm system 100. It receives information from smoke detectors, heat sensors, and other devices, and then sounds alarms or initiates other actions.

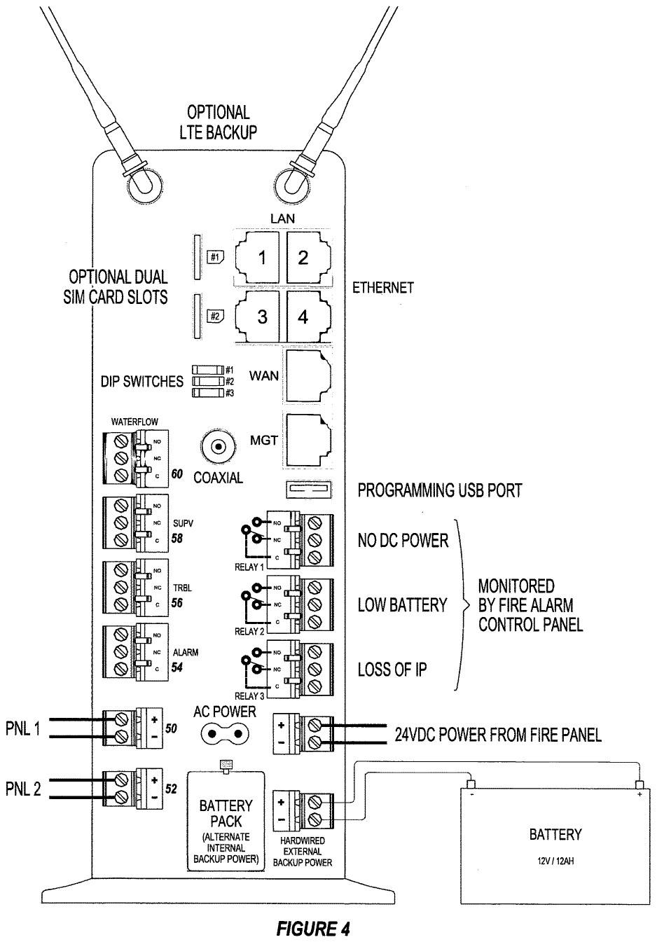

Another exemplary fire alarm system 100 shown in FIG. 3 is made up of the improved modem 110 (detailed below and in FIG. 4), connected using an ethernet wire or cable 120 directly to a Fire Alarm Control Panel (FACP) 150, thereby negating the need for a separate IP Communicator 130. The modem 110 can be integrated with or without various separate components and still function and operate as described herein. Each of these different configurations of components (or lack thereof) are meant to be covered by the scope of the present disclosure.

The IP communicator 130 is also coupled through the cloud or through a cellular network 180, to a monitoring station 190, to communicate with the monitoring station 190 in case of an emergency. There are many different types of monitoring stations 190, including a Central Monitoring Station 192, a Public Safety Answering Point (PSAP) 911/Emergency Communication Center 194, or a Proprietary Monitoring Station 196, among others.

Additionally, the FACP 150 is connected to a Notification Appliance Circuit (NAC) 160 and to a Signaling Line Circuit (SLC) 170, to receive signals and notifications upon activation in an emergency, such as a fire.

The FACP 150 comprises various components for both input and output functions and for communicating information from and to the FACP 150. An exemplary FACP 150 includes an Input-Output or I/O panel 152, which would generally include a display 154, and keyboard 156 as understood by one having ordinary skill in the art. Additionally, the FACP 150 comprises an internal dialer 157 and/or an Ethernet connection 158 for communicating with the IP communicator 130 through the dedicated wiring 140. As understood, there are a number of ways this communication can be established. The FACP 150 also contains alarm trouble and supervisory relays 159, used to signal potential issues on the fire alarm system 100, such as a problem with the system 100 itself, like a broken wire (trouble relay), or a potential problem with a monitored system component, like a closed sprinkler valve (supervisory relay), the latter of which could impact the system's effectiveness in an actual fire situation. Both types of relays will typically trigger an audible alarm or a visual signal on the display 154 of the FACP 150 alerting of an issue and requiring further investigation.

The FACP 150 is also coupled to one or more NACs 160 and SLCs 170 as described above. The NAC 160 on the FACP 150 is an electrical circuit that connects the FACP 150 to notification devices 162. These devices include bells, horns, strobes, and speakers 162, and are a vital component of fire and life safety systems 100, ensuring that notification appliances 162 activate when an alarm is detected, and alert building occupants to emergencies like fire.

The SLC 170 is likewise coupled to the FACP 150, and is a vital part of the fire alarm system 100 that allows devices to communicate with the main control panel. An SLC 170 connects devices like detectors, notification appliances, and control modules to the main control panel. Detectors, notification appliances, and control modules can include one or more smoke detectors 172, heat detectors 174, fire alarm pull stations 176, tamper notification devices 178 and waterflow indicators 179, among others. An SLC 170 can also carry power from the FACP 150 to the devices 172, 174, 176, 178, 179. The FACP 150 can use the SLC 170 to poll devices and get their status and device address, which helps the FACP 150 identify the location of the detectors 172, 174, 176, 178, 179. As shown in FIG. 1, multiple output devices or modules can be controlled by the same SLC 170.

Again, these components can be combined or integrated depending on the location of the components and functionality. For example, in an alternative embodiment shown in FIG. 3 (system) and FIG. 4 (modem), the IP communicator 130 and FACP 150 can be integrated into a single assembly or box to reduce the size of the system 100 and potential cost reduction. These different configurations of components, as well as other configurations, are meant to be covered by the scope of the present disclosure.

FIG. 2 shows an improved fire alarm system modem 110 in accordance with one embodiment of the present disclosure. As well understood, a modem is a device that allows computers, smartphones, tablets, and other devices connect to the internet by converting digital signals from these devices into analog signals that can be transmitted over telephone lines or cable networks. Modems also convert incoming analog signals into digital signals so that they can be processed by the receiving device.

FIG. 2 shows the back side of the improved fire alarm system modem 110, which is where most, if not all, outside devices are connected. Many of the devices connected to the modem 110 are well known in the industry and/or in many other industries and do not need a detailed description.

The modem 110 needs to be powered to operate. In most cases, AC power can be provided by a standard plug from a wall outlet to the AC power plug 10. A 24-volt DC connector 12 can be connected to the FACP 150 or the 24 VDC connector on the FACP 150, as needed. Additionally, a hardwired external backup power connector 14 can be connected to battery 15, such as a 12-volt battery. Alternatively, or in addition, the modem 110 may have an internal battery backup 16, that may last for 4-6 hours, as an example.

The modem further comprises a number of relays for checking or monitoring the status of certain functions. A universal Form C relay 18 can be used to check or monitor loss of IP Internet Protocol. A universal Form C relay is a switching contact that controls two circuits, one normally open and one normally closed, also known as a changeover (CO) or transfer contact. A second universal Form C relay 20 can be used to check or monitor low battery backup. Further, a universal Form C relay 22 can be used to check or monitor loss of AC or DC power.

The modem 110 includes a connector or port for a standard RG-6 coaxial cable 24 which is provided by the Internet service Provider (ISP). Although other cable and/or connectors can be used such as fiber optic cable, RG-6 is the preferred choice and primarily used for cable and satellite signal transmission for residential or commercial installations, since it is thin and easy to bend for wall or ceiling installations.

The modem 110 has a number of optional ports for IT or backup purposes. For example, optional Management Port 26 for IT or offsite IT management services, such as for real-time monitoring and firmware updates. Additionally, one or more optional SIM card ports 28, 30, for backup cellular transmissions in the event the primary ISP is down via the coaxial cable or fiber optic cable 24. One or more Ethernet Ports 32, 34, 36, 38 can be used for subscriber use on fire alarm communicator, elevator communicator, or life safety emergency communication equipment.

The improved modem 110 also comprises a cellular antenna 40 if the primary ISP and/or backup SIM card is being utilized for communication functionality. Additionally, or in the alternative, the cellular antenna 40 can be the primary ISP, for example, where hardwired ISP providers are not available. This functionality can be programable, for example as firmware, or one or more DIP switches 42, 44, 46 can be incorporated to change the functionality of the modem 110. For example, a DIP switch 42 can be manually set if the device is to be used only as a modem, whereas a DIP switch 44 can be manually set if the device is to be used only as a switch, and a DIP switch 46 can be manually set if the device is to be used as a modem and IP communicator 130 as an all-in-one unit.

The improved modem further comprises a Wide Area Network (WAN) port if the Internet Provider is a fiber optic carrier needing a media converter to convert to either CAT5 or CAT6 cable.

The modem 110 shown in FIG. 2 and described above, is to be used with a separate IP communicator 130. However, the present disclosure contemplates a modem 110 in which the IP communicator 130 is incorporated into the modem 110 itself. FIG. 3 shows another embodiment of an improved integrated fire alarm system in accordance with one embodiment of the present disclosure. While FIG. 4 shows another embodiment of an improved integrated fire alarm system modem in accordance with one embodiment of the present disclosure.

FIG. 3 shows additional detail of the system 100 in FIG. 1, but by combining or integrating some of the components, depending on the location of the components and functionality, to reduce the size of the system 100 and potential cost reduction. In this case, the modem 110, the IP communicator 130 and the FACP 150 are integrated such that the functionality of the FACP 150 is performed using the modem 110 and the FACP 150.

In doing so, instead of the FACP 150 communicating with the IP communicator 130 through the dedicated wiring 140, the FACP 150 communicates directly with the modem 110. As stated previously, there are a number of ways this communication can be established, but in the exemplary FIG. 3, the Ethernet output 158 connects by wire or cable 120 to the modem 110 at one of the Ethernet connectors 32, 34, 36, 38, while the internal dialer 157 connects by wire or cable 141 to the phone lines PNL 1 50 or PNL 2 52. Finally, the alarm trouble & supervisory relays 159 connects by wire or cable 142 directly to one or more alarms 54, 56, 58, 60. This configuration avoids the need or use of the IP Communicator 130 described in the exemplary embodiment of FIG. 1.

FIG. 4 shows the alternative embodiment modem 110 of FIG. 3 with additional features to incorporate the IP communicator 130 into the modem 110 itself (or as a combination of functions between the modem 110 and the FACP 150. In addition to the features detailed above, the integrated or combination All-in-One Built-In Fire Alarm Communicator (to the Central Station 190), comprises one or more Dial Capture via Phone Line connections 50, 52. Dial Capture via Phone Line refers to a technology where a device, typically used in security systems, intercepts the signal sent by an alarm panel, in this case the FACP 150, when it tries to dial a phone number on a traditional landline. This essentially “captures” the alarm data and transmits it through a different communication channel, like a cellular network or the Internet, to a monitoring station 190, instead of relying solely on the phone line itself. This function effectively allows older alarm systems to utilize modern communication methods without major rewiring.

The improved modem 110 also comprises one or more Form C contact inputs that come from the FACP 150 to check and monitor certain functions as described above. These contacts include, for example, a Form C Dry Contact Input from the FACP 150 for monitoring the full fire alarm 54. A second example is a Form C Dry Contact Input from the FACP 150 for monitoring the full fire trouble alarm 56. Yet another example is a Form C Dry Contact Input from the FACP 150 for monitoring the fire supervisory alarm 58. Another example is a Form C Dry Contact Input from the FACP 150 for monitoring the water flow alarm 60.

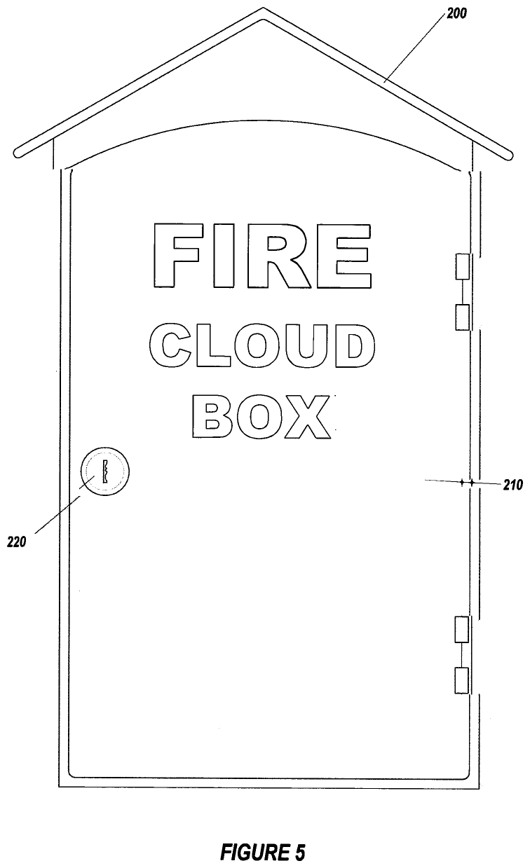

FIG. 5 shows an exemplary enclosure 200 for the modem 110 of the improved fire alarm system 100 in accordance with one embodiment of the present disclosure. The enclosure 200 comprises a door 210 that can be closed to protect the components or the modem 110, and a lock 220 to keep the contents secure. Additionally, the enclosure can be secured to a wall such that the wires or cables 120, 140, 141, 142 entering through a back opening (not shown) of the enclosure 200, can be kept from being tampered with.

Whether the improved novel modem 110 is used in conjunction with a separate IP communicator 130 or as a combination that integrates the modem 110 functionality along with that of the IP communicator 130 in a fire alarm system, there are no similar modem functionality specifically used in fire alarm systems.

It will be understood that the embodiments of the present disclosure, which have been described, are illustrative of some of the applications of the principles of the present disclosure. Although numerous embodiments of this disclosure have been described above with a certain degree of particularity, those skilled in the art could make numerous alterations to the disclosed embodiments without departing from the spirit or scope of this disclosure.

All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosed system and methods.

Additionally, joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosed apparatus, system and methods as disclosed herein.

1. A fire alarm modem for use in connection with a UL-listed commercial programmable communicator for the fire alarm industry, comprising:
a first relay connected to a fire alarm system to check for loss of AC or DC power;
a second relay connected to a fire alarm system to check for low backup battery;
a third relay connected to a fire alarm system to check for loss of IP Internet Protocol;
an internal backup battery electrically connected to an external battery to provide a 24-hour minimum backup;
at least one backup cellular antenna;
a programmable USB port, said programmable USB port providing highly reliable USB communications;
a remote management Network Cable CAT5/CAT6 Port, said remote management Network Cable CAT5/CAT6 Port, usually comprising an RJ45 port, which is used for accessing, configuring, or controlling devices from a distance, often bypassing the main operating system of a server or networking equipment; and
a universal non-proprietary programming, said universal non-proprietary programming allowing a partnership with at least one fire alarm equipment manufacturer for use in combination with said equipment manufacturer's UL-listed fire communicator;
wherein said modem is tested under UL guidelines, thereby providing a standalone UL-listed modem for a UL-listed commercial fire programmable communicator for reporting to a central station.

2. The fire alarm modem of claim 1, wherein said first relay comprises a first universal Form C relay output connected to a fire alarm system for checking for loss of AC or DC Power.

3. The fire alarm modem of claim 1, wherein said second relay comprises a second universal Form C relay output connected to a fire alarm system for checking for low backup battery.

4. The fire alarm modem of claim 1, wherein said third relay comprises a third universal Form C relay output connected to a fire alarm system for checking for loss of IP Internet Protocol.

5. The fire alarm modem of claim 1, wherein said external battery providing a 24-hour minimum backup comprises a 12-volt battery.

6. The fire alarm modem of claim 1, wherein said at least one backup cellular antenna is used when the primary ISP is being utilized for communication functionality.

7. The fire alarm modem of claim 1, wherein said at least one backup cellular antenna is used when the backup SIM card is being utilized for communication functionality.

8. The fire alarm modem of claim 1, wherein said remote management network cable, comprises an RJ45 connector for CAT5 or CAT6 cables, and is used for remotely accessing, configuring, and/or controlling the fire alarm modem.
